(19) United States
(12) Patent Application Publication
(10) Pub. No.: US 2014/0196894 A1
(43) Pub. Date: Jul. 17, 2014

(54) FLUORESCENT TAGS FOR DETECTION OF SWELLABLE POLYMERS

(71) Applicants: University of Kansas, Lawrence, KS (US); ConocoPhillips Company, Houston, TX (US)

(72) Inventors: Cory BERKLAND, Lawrence, KS (US); Huili GUAN, Lawrence, KS (US); Ahmad MORADI-ARAGHI, Bixby, OK (US); Jenn-Tai LIANG, Lawrence, KS (US); Terry M. CHRISTIAN, Bartlesville, OK (US); Riley B. NEEDHAM, Bartlesville, OK (US); James H. HEDGES, Bartlesville, OK (US); Min CHENG, Bartlesville, OK (US); Faye L. SCULLY, Bartlesville, OK (US)

(73) Assignees: University of Kansas, Lawrence, KS (US); ConocoPhillips Company, Houston, TX (US)

(21) Appl. No.: 14/059,580

(22) Filed: Oct. 22, 2013

Related U.S. Application Data
(60) Provisional application No. 61/752,780, filed on Jan. 15, 2013.

(51) Int. Cl. C09K 8/588

(52) U.S. Cl. CPC C09K 8/588
USPC 166/250.12; 507/225

(57) ABSTRACT

The invention is directed to stable crosslinked swellable fluorescently tagged polymeric microparticles, methods for making same, and their various uses. A particularly important use is as an injection fluid in petroleum production, where the expandable polymeric particles are injected into target zone and when the heat and/or suitable pH of the target zone cause degradation of the labile crosslinker and the microparticles expand. The swelled polymer diverts water to lower permeability regions and improves oil recovery. The tags allow monitoring of the presence and concentration of the tagged microparticles and ultimately allow evaluation of the performance of such treatments. Detection of polymeric microparticles in producing wells can be instructive for teaching about the character and extent of thief zones in the subsurface. Better knowledge of the reservoir flow will enable improved application of the gel treatments, improved oil recovery, and allow improved forecasting using simulation modeling.

### CROSS-REFERENCE TO RELATED APPLICATIONS

This invention claims priority to U.S. 61/752,780, filed on Jan. 15, 2013 and incorporated by reference in its entirety herein.

### FEDERALLY SPONSORED RESEARCH STATEMENT

Not applicable.

### REFERENCE TO MICROFICHE APPENDIX

Not applicable.

### FIELD OF THE DISCLOSURE

The disclosure relates to fluorescently tagged swellable polymeric particles containing anionic sites that after swelling can be further crosslinked in situ with cationic crosslinkers, such as polyvalent metal cations or cationic polymers, and methods for making same. The tags can also be applied to other swellable polymers, including ordinary swellable polymers, swellable polymers with cationic sites, that can absorb to rock in situ, and swellable polymers with hydrophobic monomers that can form hydrophobically associated polymers in situ. A particularly important use is as fluid diversion agents for sweep improvement in enhanced oil recovery applications and also as drilling fluids in petroleum production, but applications can also include uses in the hygiene and medical arts, packaging, agriculture, the cable industry, information technology, in the food industry, papermaking, use as flocculation aids, and the like. Such fluorescent tagging can be used to monitor the presence and the concentration of these polymers in produced fluids.

### BACKGROUND OF THE DISCLOSURE

A “smart gel” is a material that gels in response to a specific physical property. For example, it may gel at a specific temperature or pressure. Although finding many industrial uses, our interest in smart gels lies in their uses in oil and gas production, and in particular as a diverting agent to improve oil recovery from reservoirs.

The water injection method used in oil recovery is where water is injected into the reservoir to stimulate hydrocarbon production. Water is injected for two reasons. First, for pressure support of the reservoir (also known as voidage replacement). Secondly, to sweep or displace the oil from the reservoir, and push it towards an oil production well. Normally only 20% of the oil in a reservoir can be extracted, but water injection increases that percentage (known as the recovery factor) and maintains the production rate of a reservoir over a longer period of time.

However, sweep recovery is limited by the so-called “thief zones,” whereby water or other fluid preferentially travels through the more permeable regions of the reservoirs, bypassing less permeable zones, leaving unswept oil behind.

One means of further improving recovery is to block thief zones with a polymer or other material, thus forcing water or other injection fluids through the less permeable regions. Gels have been used to block thief zones, but gels are hard to pump due to their high viscosity and the pumping tends to shear the gels as well, making them less effective in blocking thief zones.

U.S. Pat. No. 6,454,003, U.S. Pat. No. 6,984,705 and U.S. Pat. No. 7,300,973 describe what might be called a “smart polymer” since it changes in response to particular stimuli. These patents describe an expandable crosslinked polymeric particle having an average particle diameter of about 0.05 to 10 microns. The particle is highly crosslinked with two types of crosslinkers, one that is stable and second one that is labile. The excess crosslinking makes the initial particles quite small, allowing efficient propagation through the pores of a reservoir. On heating to reservoir temperature and/or at a predetermined pH or other stimuli, the labile internal crosslinkers disintegrate, allowing the particle to further expand by absorbing additional injection fluid, usually water. The initial polymeric particle is sometimes called the “kernel” before its expansion, in analogy to the way a kernel of popcorn “pops” in response to certain stimuli, such as heat.

The unique properties of this particle allows it to fill the high permeability zones—commonly called thief zones or streaks—and then be expanded so that the swollen particle blocks the thief zones and subsequent injections of fluid are forced to enter the remainder of the reservoir, more effectively sweeping the reservoir. However, the method is limited in practice because subsequent water injections always remove some of the polymer, thus the thief zones become washed out and again the injection fluid bypasses the thief zones. The reason for the washout is not completely certain, but our own research suggested that the swollen polymer is not in gel form, thus although viscous, is a liquid and can be washed out of the porous substrate.

To address this problem, ConocoPhillips and the University of Kansas developed an improved smart gel, wherein the expandable polymeric polymers described above also contain crosslinkable anionic sites. Once the labile crosslinkers disintegrates, the particles swell, thus exposing the anionic sites. The swelled polymer is further crosslinked using cationic crosslinkers, such as polyvalent metal crosslinkers or cationic polymers to produce gels. US2010314114, expressly incorporated by reference herein, describes these swellable polymers with anionic sites and the various tertiary crosslinkers that can be used to gel same in situ, thus preventing washout.

However, the above anionic swellable polymers could be further improved if their progress in situ could effectively be monitored. Thus, what is needed in the art are smart gels that also comprise some detectable label, so long as the label does not otherwise interfere with the complex chemistry of these smart gels.

Further, it would be desirable if such as method could be applied to a wide variety of swellable polymers, including those described in U.S. Pat. No. 6,454,003, U.S. Pat. No. 6,984,705 and U.S. Pat. No. 7,300,973, US2010314114, WO2012021213 and WO20100147901.

### SUMMARY OF THE DISCLOSURE

The disclosure generally relates to fluorescently tagged smart gels comprising polymeric microparticles that have stable and labile crosslinkers, allowing swelling in situ in response to a particular stimuli. The swelled polymeric particles contain anionic sites that become accessible on swelling of the polymer and allow further crosslinking using cationic crosslinkers, such as polyvalent metal crosslinkers or cationic polymers to produce gels. The microparticles and/or gel can be monitored due to the fluorescent tag.

One important class of workable fluorescent tags is the fluorone dyes, of which there are many examples, including fluorescein, erythrosine and rhodamine. Examples include Rhodamine 6G, Rhodamine B, Rhodamine 123, carboxytetramethylrhodamine (TAMRA), tetramethylrhodamine (TMR) and its isothiocyanate derivative (TRITC), sulforhodamine B, sulforhodamine 101 (and its sulfonyl chloride form Texas Red), Rhodamine Red, Alexa 546, Alexa 555, Alexa 633, DyLight Fluors such as DyLight 550 and DyLight 633, Eosin, Auramine O, Carboxyfluorescein, Fluorescein isothiocyanate (FITC), Fluorescein amidite (FAM), Merbromin, Erythrosine, Rose Bengal, Oregon Green, Tokyo Green, SNAFL, and carboxynaphthofluorescein.

Another important class are the phenanthridine dyes, including EtBr, propidium iodide, and their derivatives, such as ethidium bromide-N,N′-bisacrylamide (abbreviated EtBrXL).

Still another important class of fluorescent tags includes the naphthalene derivatives, such as 1-anilinonaphthalene-8-sulfonate (ANS), dansyl, prodan, and N-(N-(acrylamido)ethyl)-4-chloro-1-hydroxy-2-naphthamide.

Each of these three classes of dyes have been tested in the invention and found to work, allowing visual monitoring of the particles and/or gels, yet do not overly interfere with the complex chemistry of the smart gels. These results suggest that the invention is broadly applicable to any fluorescent tag that can be incorporated into the polymeric microparticle.

Fluorescent tags include but are not limited to the acridine dyes (proflavin, acridine orange, acridine yellow etc.); cyanine dyes (cyanine, indocarbocyanine, oxacarbocyanine, thiacarbocyanine, and merocyanine); fluorone dyes (fluorescein, erythrosine, rhodamine, ALEXA fluors, DyLight fluors, etc.); oxazin dyes (Nile blue, Nile red, creyl violet); phenanthridine dyes (EtBr, Propidium iodide); naphthalene based dyes (1-anilinonaphthalene-8-sulfonate (ANS), dansyl, prodan etc.); coumarin derivatives (aminomethylcoumarin acetate, 3-benzoxazol-2-yl-coumarins, 7-aminocoumarin); oxadiazole derivatives (pyridyloxazole, nitrobenzoxadiazole and benzoxadiazole); pyrene derivatives (cascade blue etc.); arylmethine derivatives (Auramine, crystal violet, malachite green) and tetrapyrrole derivatives (porphin, phtalocyanine, bilirubin, etc.).

If needed, the above dyes can be covalently linked to a crosslinker, such as bis-acrylamide, for the purposes of facilitating their covalent incorporation into the polymers of the invention.

The amount of fluorescent tag can vary substantially, depending on its intended use. However, generally the lowest amount that will allow detectable signal should be used and thus is about 0.1-1000 ppm or, preferably, about 1-100 ppm or, most preferably, about 25-50 ppm.

The tertiary crosslinker is any crosslinker that can crosslink the exposed anionic sites in the swelled polymer, including at least inorganic cationic crosslinkers and organic cationic crosslinkers. Some of the more common inorganic crosslinking agents include cations of chromium, iron, vanadium, aluminates, borates, titanium, zirconium, aluminum, and their salts, chelates and complexes thereof. Complexed or chelated metal cations may be preferred because they slow the rate of gelation, as are nanoparticles that slowly release metal ions. Common organic cationic polymers include polyethyleneimine and other alkyl or alkene polyamines and the polyquaternium polymers.

The anionic sites in the swellable microparticles include the various acids such carboxylic, nitric, phosphoric, chromic, sulfuric, sulphonic, vinylogous carboxylic acids and the like. Suitable polymers having anionic sites include biopolysaccharides, cellulose ethers, and acrylamide-based polymers, with negatively charged monomers.

Preferably, the smart gels of the invention comprise highly crosslinked expandable polymeric particles having fluorescent tags as well as labile crosslinkers and stable crosslinkers, wherein at least one of the monomers that make up the polymer or copolymer contains anionic sites. A suitable cationic crosslinker is added to the particles after they are made or after the labile crosslinker degrades or any time therebetween.

In certain embodiments it may be possible to convert a nonionic polymer to an anionic polymer, but the incorporation of anionic monomers is preferred to ensure adequate dispersion of anionic sites and for ease of use.

In reservoir applications, the cationic crosslinker can be injected after swelling of the polymer, but it can also be combined with the unexpanded particle in the initial injection fluid, and if necessary for the application, the rate of gelation can be delayed by means known in the art in order to allow the particle to fully swell before commencing the gelation. In yet another embodiment, anionic particles and a second population of cationic crosslinker loaded particles can be combined and used.

The polymer of the invention has particular use in oil recovery, as described above, and is preferably a hydrophilic polymer for this application. However, such polymers would find uses in all of the arts where swellable polymers are in current use and loss is not desired, including as filler for diapers and other hygiene products, medical devices such as orthopedic insoles, ocular devices, and biomimetic implants, wipe and spill control agents, wire and cable water-blocking agents, ice shipping packs, controlled drug release, agricultural uses (e.g., soil additive to conserve water, plant root coating to increase water availability, and seed coating to increase germination rates), industrial thickeners, specialty packaging, tack reduction for natural rubber, fine coal dewatering, and the like.

The invention was herein exemplified herein with anionic swellable polymers, but the breadth of positive results achieved herein suggests that tagged polymers could be used with other swellable polymers that function in slightly different ways. For example, we expect the invention can be applied to the original swellable polymers, described in U.S. Pat. No. 6,454,003, U.S. Pat. No. 6,984,705 and U.S. Pat. No. 7,300,973, since the chemistry is similar, and only omits the cationic groups and tertiary crosslinker. As another example, WO2010132851 describes swellable polymers with 0.1-5% hydrophobic monomers, that when swelled or “popped” in situ can form a hydrophobically associative polymer in the reservoir. As yet another example, WO20100147901 describes swellable polymers with cationic sites that can aid cationic sites adsorb to said subterranean formation thus making said particle resistant to washout. Each of the above patents are incorporated by reference in their entireties.

By “polymer” what is meant is polymerized monomers, including mixtures of two or more repeat units (e.g., copolymers and heteropolymers).

A “stable crosslinker” is defined herein to be any crosslinker that is not degraded under the stimuli that causes the labile crosslinker to disintegrate. Representative non-labile crosslinkers include methylene bisacrylamide, diallylamine, triallylamine, divinyl sulfone, diethyleneglycol diallyl ether, and the like and combinations thereof. A preferred non-labile crosslinking monomer is methylene bisacrylamide.

The “labile crosslinker” is defined herein to be any crosslinker that decays or disintegrates on application of a particular stimulus, such as irradiation, suitable pH, temperature, etc. and combinations thereof. Representative labile crosslinkers include acrylate or methacrylate esters of di, tri, tetra hydroxy compounds including ethyleneglycol diacrylate, polyethyleneglycol diacrylate, trimethylopropane trimethacrylate, ethoxylated trimethylol triacrylate, ethoxylated pentaerythritol tetracrylate, and the like; divinyl or diallyl compounds separated by an azo such as the diallylamide of 2,2′-azobis(isbutyric acid) and the vinyl or allyl esters of di or tri functional acids, and combinations thereof. Preferred labile crosslinking monomers include water-soluble diacrylates such as polyethylene glycol (PEG) 200-1000 diacrylate, especially PEG 200 diacrylate and PEG 400 diacrylate, and polyfunctional vinyl derivatives of a polyalcohol such as ethoxylated (9-20) trimethylol triacrylate and polymethyleneglycol diacrylate.

US2008075667, herein incorporated by reference, describes additional acid labile ketal cross linkers that can be used in the invention. Such acid labile ketal crosslinker have one of the following formulas:

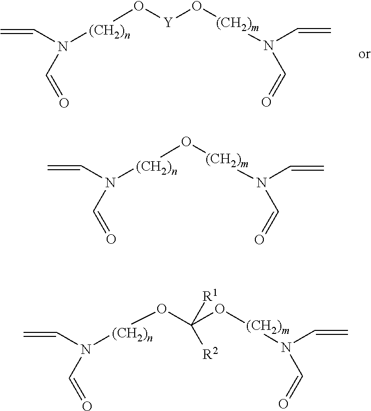

wherein Y is a lower alkyl, n and m are independently an integer of between 1 and 10 and R¹ and R² are independently a lower alkyl.

In particular, 2-bis[2,2′-di(N-vinylformamido)ethoxy]propane (BDEP) and 2-(N-vinylformamido)ethyl ether (NVFEE) are described and may be suitable in acidic environments, or where the acid is later added thereto. Such cross linkers can be advantageously combined with the monomers described therein, such as N-vinyl pyrollidone, N-vinyl formamide, N-vinylacetamide, N-vinylacetamine and other vinyl containing polymers and copolymers thereof, and may be preferred where the neurotoxic effects of acrylamide are to be avoided.

“Cationic crosslinkers” are defined herein to be molecules that can crosslink the anionic polymers, and include cationic polymers and polyvalent metals, chelated polyvalent metals, and compounds or complexes capable of yielding polyvalent metals.

By “complex” or “complexed” what is meant is that the polyvalent metal crosslinker is present with or within another molecule that will release the metal ions under the conditions of use, and includes the use of metal salts, chelates, nanoparticles, and the like.

The proportion of stable to labile crosslinker can also vary depending on how much swelling on stimulus is required, but in the enhanced oil recovery applications a great deal of swelling is desired to effectively block the thief zones and increase the mobilization and/or recovery rate of hydrocarbon fluids present in the formations. Thus, the concentration of labile crosslinker greatly exceeds the concentration of stable crosslinker. To obtain sizes in the range of about 0.05 to about 10 microns suitable for injection fluid use, the crosslinker content is about 1,000-250,000 ppm or preferably, 5,000-100,000 ppm or most preferably 9,000 to 60,000 ppm of labile crosslinker and from 1-1000 ppm or, preferably, 100-500 pm or, most preferably, about 300 ppm of non-labile crosslinkers.

Combinations of multiple stable and labile crosslinkers can also be employed advantageously. Reaction to stimuli can also be controlled by labile crosslinker selection, as needed for particular reservoir conditions or for the application at issue. For example, judicious selection of labile crosslinkers—one that degrades at a very high temperature and another at a lower temperature—can affect the temperature and pH at which the kernel pops.

Other crosslinkers include, but are not limited to, diacrylyl amides, diacrylylpiperazine, diallyltartardiamide (DATD), dihydroxyethylene-bis-acrylamide (DHEBA), and bis-acrylylcystamine (BAC), trimethylolpropane trimethacrylate (TMPTMA), propyleneglycol triacrylate (PGTA), tripropyleneglycol diacrylate (TPGDA), allyl methacrylate (AMA), triethyleneglycol dimethacrylate (TEGDMA), tetrahydrofurfuryl methacrylate (TFMA) and trimethylolpropane triacrylate (TMPTA). Multifunctional crosslinkers include, but are not limited to, pentaerythritol triacrylate, 1,5 pentane diol dimethacrylate, and pentaerythritol triallylether.

It is believed that the carboxylate and/or other anionic constituents are the crosslinking sites in the polymer and that the polymer cannot gel if there are too few crosslinking sites in the polymer, i.e., less than about 1.0 mole percent based on the total number of monomeric groups in the polymer. Thus, mole % anionic sites should be at least 0.5%, preferably 0.5-5%, or about 1-2%. U.S. Pat. No. 4,683,949 shows gelation rates for a number of different polymers and conditions and is incorporated herein by reference.

The solvent of the gelation system is an aqueous liquid, such as deionized water, potable water, fresh water, or brine having a total dissolved solids concentration up to the solubility limit of the solids in water. Inert fillers known in the art may also be added to the gelation system to reinforce the subsequent gel if desired or for use as proppants. Such fillers include crushed or naturally fine rock material or glass beads, sand and the like.

Representative anionic monomers that can be used include the following acids and their sodium, potassium and ammonium salts: acrylic acid, methacrylic acid, maleic acid, itaconic acid, 2-propenoic acid, 2-methyl-2-propenoic acid, 2-acrylamido-2-methylpropane sulfonic acid, sulfopropyl acrylic acid and other water-soluble forms of these or other polymerizable carboxylic or sulphonic acids, sulphomethylated acrylamide, allyl sulphonic acid, vinyl sulphonic acid, and the like. Preferred anionic monomers include sodium acrylates.

Representative nonionic monomers include acrylamide, N-isopropylacrylamide, N,N-dimethylacrylamide, N,N-diethylacrylamide, dimethylaminopropyl acrylamide, dimethylaminopropyl methacrylamide, acryloyl morpholine, hydroxyethyl acrylate, hydroxypropyl acrylate, hydroxyethyl methacrylate, hydroxypropyl methacrylate, dimethylaminoethylacrylate (DMAEA), dimethylaminoethyl methacrylate (DMAEM), maleic anhydride, N-vinyl pyrrolidone, vinyl acetate and N-vinyl formamide. Preferred nonionic monomers include acrylamide, N-methylacrylamide, N,N-dimethylacrylamide and methacrylamide. Acrylamide is more preferred. N-vinyl pyrrolidone, N-vinyl formamide, N-vinylacetamide, N-vinylacetamine and copolymers may be preferred with the acid labile ketal crosslinkers of US2008075667.

Cationic and betaine monomers can be combined with the polymeric particles containing anionic sites, but their use is not preferred as they would compete for binding to the anionic sites. However, small amounts may be acceptable, provided the anionic sites predominate.

Of course, in swellable polymers containing cationic sites, however, a higher percentage of cationic sites is acceptable.

Representative swellable polymers also include polymers and copolymers of acrylamide and 2-acrylamido-2-methyl propane sulfonic acid (and its sodium salt), copolymers of acrylamide and sodium acrylate, terpolymers of acrylamide, 2-acrylamido-2-methyl propane sulfonic acid (and its sodium salt) and sodium acrylate and 2-acrylamido-2-methylpropane sulfonic acid, (and its sodium salt) poly(2-hydroxyethyl methacrylate), poly(2-hydroxypropyl methacrylate), poly(isobutylene-co-maleic acid), and the like.

The “polyvalent metal crosslinker” of the present invention is defined as a salt or a complex of a tri- or quatravalent metal cation wherein the metal cation is capable of crosslinking a polymer having anionic sites. Exemplary polyvalent metal crosslinking agents useful in the practice of the present invention are complexes or chelates of Al³⁺, Fe³⁺, Cr³⁺, Ti⁴⁺, Sn⁴⁺, Zr⁴⁺ and the like. Preferred crosslinking agents of the present invention contain Al³⁺, Zr⁴⁺ or Cr³⁺, and their acetates, nitrates, phosphates, carbonates, tartrates, malonates, propionates, benzoates, or citrates thereof, and the like. Combinations of cationic crosslinkers can also be used.

The polyvalent metal cations can be employed in the form of complexes with an effective sequestering amount of one or more chelating or sequestering anions. Slow release nanoparticles and macroparticles can also be employed. Chromium and zirconium are the preferred cations in high salinity brines including hard brine. High salinity brine contains on the order of at least about 30,000 ppm total dissolved solids. Thus, the combination of the particular chelating or sequestering agent in conjunction with the preferred chromium(III) and Zr(IV) cations confers high brine tolerance.

The cationic polymers of the invention include homopolymers of the following: dimethyl diallyl ammonium chloride, ethyleneimine, methacrylamido propyl trimethyl ammonium chloride, 2-methacryloyloxyethyl trimethyl ammonium methosulfate and diquaternary ionene, polylysine, and peptides containing lysine groups and the like. A preferred cationic crosslinker is polyethyleneimine (PEI), which has a high charge ratio, but other alkyl or alkene polyamines can also be used.

The tagged particles can be prepared by methods known in the art, including the inverse emulsion polymerization technique described in U.S. Pat. No. 6,454,003, U.S. Pat. No. 6,729,402 and U.S. Pat. No. 6,984,705. Particle suspensions are prepared by mixing the particles with injection fluid, or inverse suspensions of particles are inverted with a surfactant and/or sufficient shearing and additional injection fluid can be added if needed.

In addition to the expandable polymeric particles having anionic sites and tags and both labile and stable crosslinkers and the cationic crosslinker, the aqueous solution may also contain other conventional additives including chelating agents, pH adjusters, initiators and other conventional additives, accelerators, retardants, surfactants, stabilizers, etc., as appropriate for the particular application. The same additives can be used with swellable polymers having cationic sites or hydrophobic residues, or the original swellable polymers.

The rate of gelation with the polymers can be controlled, as is known in the art. Thus, temperature and pH can affect the rate of gelation, as can the use of metal complexes or metal nanoparticles or other means to slow the rate of release of metal cations, as needed for a particular application. In addition, the gels can be destroyed with the use of strong oxidizing agents such as sodium hypochlorite.

In one embodiment, is a composition comprising a fluid, a cationic crosslinker and expandable tagged polymeric particles having anionic sites and both labile and stable crosslinkers. In another embodiment, is a composition comprising expandable tagged polymeric particles having anionic sites and both labile and stable crosslinkers, said particle combined with a fluid and a cationic crosslinker that is capable of crosslinking the anionic sites in the popped polymer and forming a gel that is resistant to washout.

In another embodiment, is a swellable polymer that is tagged. That swellable polymer can be made with cationic sites or hydrophobic monomers, or such can be omitted. Such tagged swellable polymers can be combined with a fluid to make an injection fluid, to which conventional additives can be added.

The composition can also be a mixture of tagged and untagged polymeric particles.

In another embodiment, the invention is a composition comprising highly crosslinked expandable tagged polymeric particles having an unexpanded volume average particle size diameter of from about 0.05 to about 10 microns and a crosslinking agent content of from about 1,000 to about 200,000 ppm of labile crosslinkers and from 1 to about 300 ppm of stable crosslinkers, combined with a cationic crosslinker and a fluid.

In another embodiment, the invention is a method of increasing the recovery of hydrocarbon fluids in a subterranean formation comprising injecting into the subterranean formation a composition comprising a fluid and any of the tagged polymeric particles described herein, said polymeric particle has a smaller diameter than the pore throats of the subterranean formation, and said labile crosslinkers break under the conditions of temperature and suitable pH in the subterranean formation to allow the polymeric particle to expand. That injection fluid can be combined with tertiary crosslinkers or known additives.

The tagged particle and resulting gel can be monitored using fluorescence or ultraviolet spectroscopy.

In preferred embodiments, the tagged polymeric particles can be a copolymer of acrylamide and sodium acrylate, the stable crosslinker can be methylene bisacrylamide, and the labile crosslinker can be a polyethylene glycol diacrylate. The cationic crosslinker is selected from polyethyleneimine, Al³⁺, Fe³⁺, Cr³⁺, Ti⁴⁺, Sn⁴⁺, or Zr⁴⁺.

In preferred embodiments, the tag is a fluorone dye, a phenanthridine dye, or a naphthalene based dye, but it is likely that most known dyes can be used herein, provided that they can be covalently incorporated into the polymeric particle and do not overly interfere with popping or subsequent gelling.

As used herein “ppm” refers to mass ratio in parts per million, based on the mass of a single specie to the total mass of the solution.

As used herein a “microparticle” is about 0.1-10 microns in average size.

As used herein “B29” refers to expandable polymeric microparticles having anionic sites therein.

“F” refers to fluorescent tags.

“Rh” refers to methacryloxyethyl thiocarbamoyl rhodamine B,

“EtBr-XL” refers to ethidium bromide-N,N′-bisacrylamide and “N” refers to N-(N-(acrylamido)ethyl)-4-chloro-1-hydroxy-2-naphthamide. Thus, “F-B29-Rh” refers to a rhodamine tagged expandable polymeric microparticles having anionic sites therein.

“AM-SA” is an acrylamide-sodium acrylate copolymer.

“D12” is a degradable cage structured microparticle made by polymerization of sodium AMPS in presence of PEI and chromium acetate and a labile crosslinker identified as XL2. It is described more fully in WO2012021213, and incorporated herein by reference.

### DESCRIPTION OF FIGURES

FIG. 1 Reaction components of fluorescent-tagged B29 anionic polymeric microparticles.

FIG. 2 Chemical structures of two fluorescent monomers and one fluorescent crosslinker.

FIG. 3 Fluorescence calibration curve for poly(AM-SA-EtBr) (Conc.: 19˜579 ppm) in Synthetic Brine A.

FIG. 4 Fluorescence calibration curve for poly(AM-SA-EtBr) (Conc.: 19˜153 ppm) in Synthetic Brine A.

FIG. 5 Fluorescence calibration curve for poly(AM-SA-N) (Conc.: 3˜178 ppm) in Synthetic Brine A.

FIG. 6 Fluorescence calibration curve for poly(AM-SA-N) (Conc.: 3˜27 ppm) in Synthetic Brine A.

FIG. 7 Popping of poly(AM-SA-EtBr) at 65° C. in Synthetic Brine A.

FIG. 8 Popping of poly(AM-SA-N) at 65° C. in Synthetic Brine A.

FIG. 9 Gelation of poly(AM-SA-N) with d12, 100 ppm Cr at 75° C. in Synthetic Brine A.

### DETAILED DESCRIPTION

Polymeric microparticles with anionic sites were shown to be useful in blocking thief zones deep into the oil producing formations. Such systems are superior to the commonly used polymeric gels made with partially hydrolyzed polyacrylamides and Cr(III) acetate crosslinking systems, which gel in very short times even at low temperatures such as 40° C. and thus have difficulty reaching deep into a reservoir before gelling. Unlike the commonly used gelling systems which exhibit high viscosities, and are difficult to pump, the newly invented systems exhibit initial water-like viscosities, and can easily be placed deep into the formation before the microparticles expand and crosslink in situ with a tertiary crosslinker to form a stable gel, resistant to washout.

It has been desirable to be able to determine the concentration of the polymeric microparticles at low concentration in produced water. Such measurements are needed to determine polymer retention in porous media in the laboratory experiments, as well as in field treatments. Detection of polymeric microparticles as well as their expanded products would also be useful in the field for monitoring purposes. Detection of polymers in produced brine could be used to employ techniques to avoid fouling of the production facilities. Detection of polymeric microparticles in the producing wells can also be instructive for teaching about the character and extent of the thief zones in the subsurface. Better knowledge of the reservoir flow system will enable improved application of the polymeric microparticle gel treatments and improved oil recovery. Such information will also enable an improved forecast of the treatment using simulation modeling.

A sensitive technique for monitoring of microparticles has been developed herein and employs fluorescent tagging of such polymeric microparticles. Extensive laboratory experiments performed with crosslinkable microparticles containing small amounts of fluorescent monomers having anionic sites referred to F-B29 polymers, proved that we could detect these polymers at ppm levels in brines, at least in the laboratory. Field experiments will confirm the usefulness of such tagged polymers under reservoir conditions.

These experiments also confirmed that such F-B29 polymeric microparticles “pop” similar to untagged B29 polymeric microparticles and can be crosslinked with tertiary crosslinkers to produce suitable gels for blocking thief zones deep in oil producing formations. Thus, the tagging chemistry did not significantly interfere with popping and subsequent gelling reactions.

Alternatively, F-B29 polymeric microparticles may be used in low concentrations as tracing agents along with untagged B29 polymeric microparticles in treatment of thief zones.

Popping time is a strong function of aging temperature—that is the higher the temperature, the shorter the popping time. After varying aging times at the indicated temperature, the resistance factor was determined by injecting a small amount of water. At the same time the content of one ampoule was used to determine the viscosity and extent of polymer popping.

The brine composition used in our experiments is given in Table 1.

TABLE 1
Brine A Composition

| | | |
|---|---|---|
| Bicarbonate | ppm | 1621 |
| Chloride | ppm | 15330 |
| Sulfate | ppm | 250 |
| Calcium | ppm | 121 |
| Potassium | ppm | 86.9 |
| Magnesium | ppm | 169 |
| Sodium | ppm | 11040 |
| Strontium | ppm | 7.57 |

### PRIOR ART

We ran a number of slim tube tests in which we injected about 1 pore volume of BRIGHTWATER® particles (NALCO®, copolymer of acrylamide and sodium AMPS crosslinked with methylene bis-acrylamide and PEG diacrylate) into 40′ slim tubes packed with sand. The sand pack was then heated (two temperatures were used—150° F. and 190° F.) to allow the polymer to pop. Afterwards, water was injected into the sand packs and the resistance to the flow of water measured (data not shown). While we observed flow resistance in all eight sections of the slim tube initially, this effect gradually was reduced from sections 1 to 8 sequentially. Residual Resistance Factors for all sections for all sections of the slim tube were reduced to about 1.0 within 1 pore volume of water injection indicating a complete washout.

### Fluorescent Tags

Extensive laboratory experiments were performed to produce fluorescent tagged polymeric microparticles, referred to as F-B29 herein.

The various components used to produce the F-B29-Rh, F-B29-N and F-B29-EtBr-XL are listed in Table 2.

TABLE 2

| | | |
|---|---|---|
| Description | Ingredient | Amount |

a: Composition of F-B29-Rh

| | | | |
|---|---|---|---|
| Monomer, M1 | Acrylamide | 18 | g |
| Monomer, M2 | Sodium Acrylate | 1.41 | g |
| Water | H₂O | 18.5 | g |
| Crosslinker, XL1 | Methylenebisacrylamide, 0.1% | 1.5 | g |
| Crosslinker, XL2 | Polyethyleneglycol (PEG-258) | 85 | mg |
| | diacrylate | | |
| Fluorescent | Methacryloxyethyl thiocarbamoyl | 2.0 | mg |
| monomer | rhodamine B | | |
| Oil | Kerosene | 20 | g |
| Emulsifier I | Span83 | 2.3 | g |
| Emulsifier II | Polyoxyethylene sorbitol | 2.7 | g |
| | hexaoleate | | |
| Initiator | Vazo 52 | 38 | mg |

b: Composition of F-B29-N

| | | | |
|---|---|---|---|
| Monomer, M1 | Acrylamide | 18 | g |
| Monomer, M2 | Sodium Acrylate | 1.41 | g |
| Water | H₂O | 18.5 | g |
| Crosslinker, XL1 | Methylenebisacrylamide, 0.1% | 1.5 | g |
| Crosslinker, XL2 | Polyethyleneglycol (PEG-258) | 84 | mg |
| | diacrylate | | |
| Fluorescent | N-(N-(acrylamide)ethyl)-4-chloro-1- | 21.8 | mg |
| monomer | hydroxy-2-naphthamide | | |
| Oil | Kerosene | 20 | g |
| Emulsifier I | Span83 | 2.3 | g |
| Emulsifier II | Polyoxyethylene sorbitol | 2.7 | g |
| | hexaoleate | | |
| Initiator | Vazo 52 | 38 | mg |

C: Composition of F-B29-EtBr-XL

| | | | |
|---|---|---|---|
| Monomer, M1 | Acrylamide | 18 | g |
| Monomer, M2 | Sodium Acrylate | 1.41 | g |
| Water | H₂O | 18.5 | g |
| Crosslinker, XL1 | Methylenebisacrylamide, 0.1% | 1.5 | g |
| Crosslinker, XL2 | Polyethyleneglycol (PEG-258) | 84 | mg |
| | diacrylate | | |
| Fluorescent | EtBr-N,N′ bis acrylamide | 5.1 | mg |
| monomer | | | |
| Oil | Kerosene | 20 | g |
| Emulsifier I | Span83 | 2.3 | g |
| Emulsifier II | Polyoxyethylene sorbitol | 2.7 | g |
| | hexaoleate | | |
| Initiator | Vazo 52 | 38 | mg |

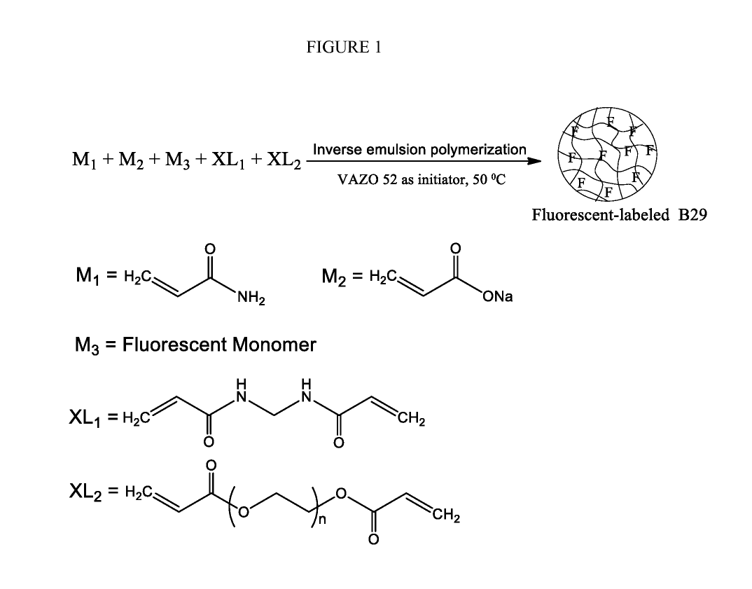

FIG. 1 shows reaction components of fluorescent-tagged B29 anionic polymeric microparticles.

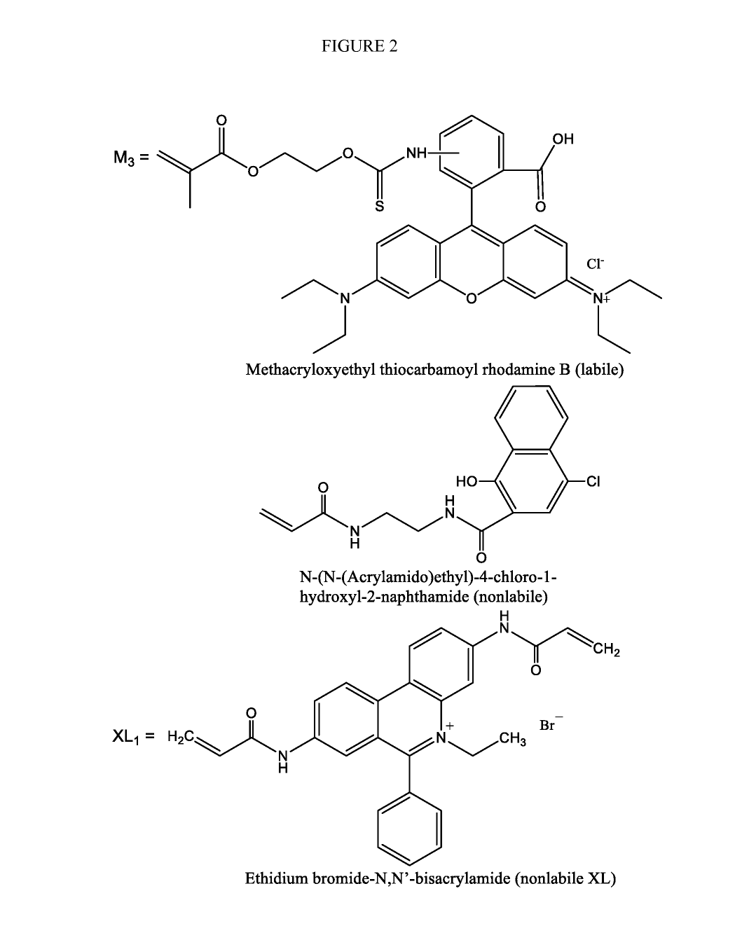

FIG. 2 shows the chemical structures of two fluorescent monomers and one fluorescent crosslinker used in our studies.

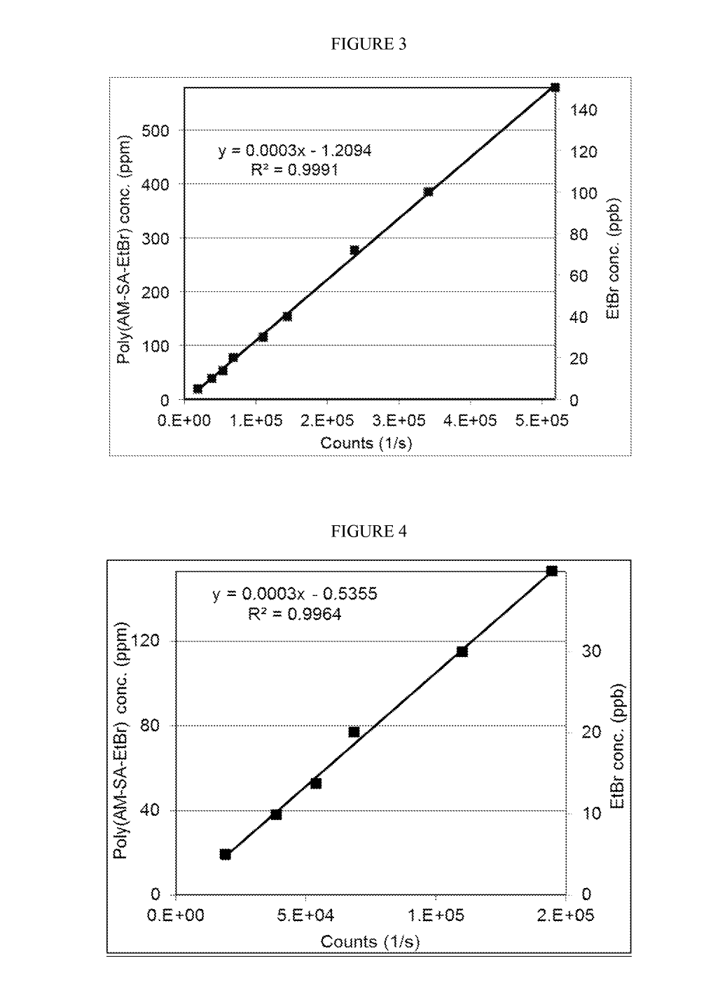

FIG. 3 shows the calibration curve for poly(AM-SA-EtBr), F-B29-EtBr, (Conc.: 19˜579 ppm) in Synthetic Brine A prepared by placing 3 ml of sample with increasing amounts of F-B29-EtBr in brine in a 1×1×4 cm cuvette and stimulating fluorescence at 305 nm and measuring emission at 486 nm using a fluorescent spectrophotometer. FIG. 3 shows a linear relation for this polymer over a wide range of fluorescent concentration—1-100 ppb. As this plot shows, polymer concentration can be determined with a high degree of confidence.

FIG. 4 shows the calibration curve for poly(AM-SA-EtBr) in Synthetic Brine A in a concentration range of 19˜153 ppm.

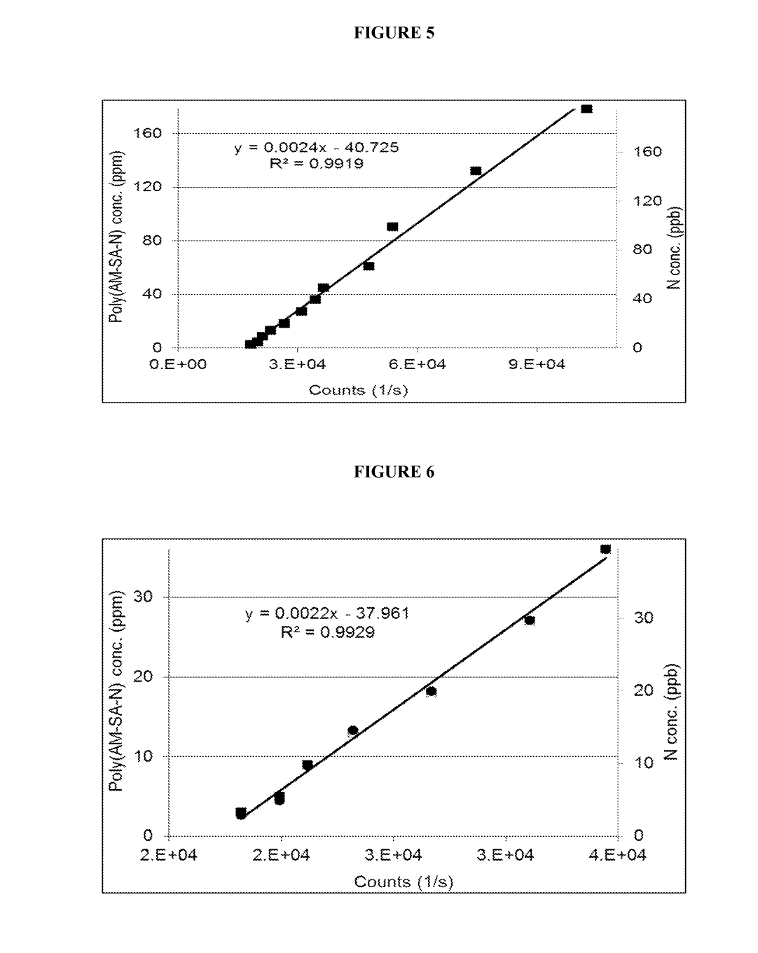

FIG. 5 shows the calibration curve for poly(AM-SA-N) in a concentration range of 3˜178 ppm in Synthetic Brine A. As this figure shows, selection of a proper tagging agent can improve the detection limit for these microparticles.

FIG. 6 shows calibration curve for the same microparticles measured in a concentration range of 3˜36 ppm in Synthetic Brine A.

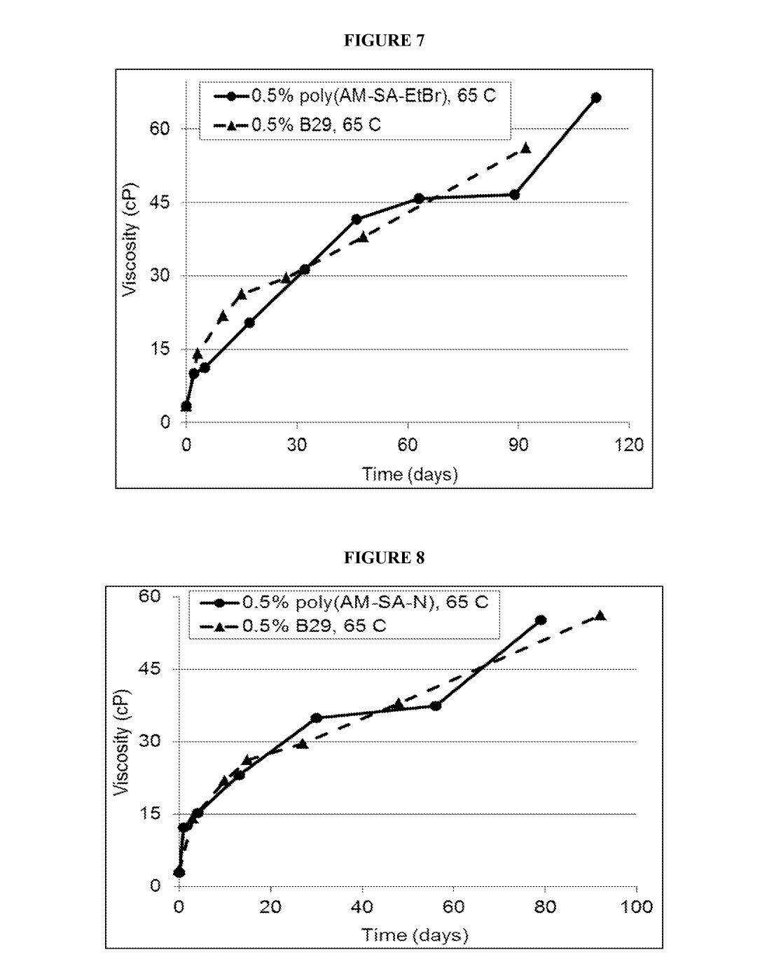

FIG. 7 compares the popping rate of poly(AM-SA-EtBr), F-B29-EtBr, at 65° C. in Synthetic Brine A with B29 without a tagging agent. As this figure shows, placement of a tagging agent for detection purposes does not alter the popping rate of the microparticles.

A similar behavior is observed in FIG. 8, showing the popping of tagged poly(AM-SA-N) versus untagged B29 microparticles aged at 65° C. in Synthetic Brine A.

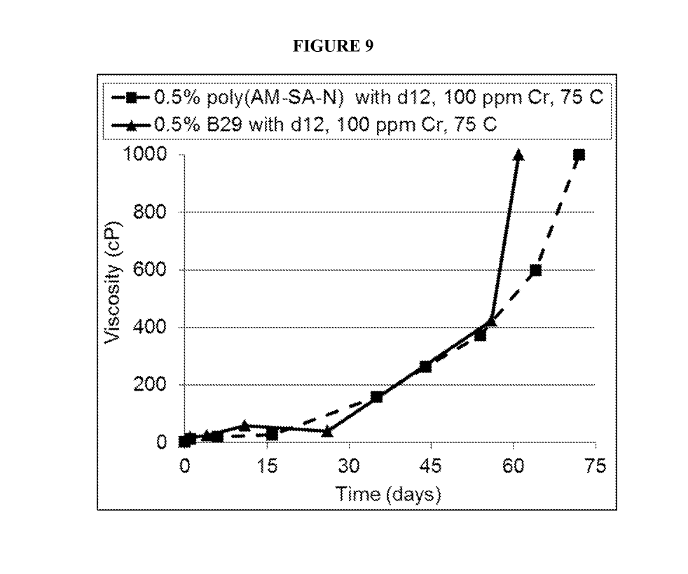

FIG. 9 compares gelation rate for the tagged poly(AM-SA-N) microparticles with untagged B29, poly(AM-SA) with d12 crosslinker containing 100 ppm Cr both aged at 75° C. in Synthetic Brine A. As can be seen, gel time did not significantly change.

This invention would facilitate monitoring the concentration of polymeric microparticles in the laboratory as well as in field treatments, which is quite important in designing of field treatments. Detection of polymeric microparticles or popped polymer in the producing wells can be instructive for teaching about the character and extent of the thief zones in the subsurface. Better knowledge of the reservoir flow system will enable improved application of the polymeric microparticle gel treatments and improved oil recovery. Such information will also enable an improved forecast of the treatment using simulation modeling. This invention would also have value in monitoring produced brines for production of polymers that otherwise might foul production facilities. Early knowledge of the production of such polymers might avert major expenses of production facilities.

Fluorescence or ultraviolet spectroscopy can be used to detect the presence and concentration of tagged microparticles or popped polymers. A fluorometer or a UV spectrometer can be used in the field to determine the presence and the concentration of such polymers in produced brines. Early detection of such compounds should help in avoiding field wide fouling of production equipment.

Other analytical techniques such as Dow Color tests, Size Exclusion Chromatography, etc., could be used for this purpose. The critical aspects of such techniques are their sensitivity in detecting the lowest concentration in produced brines as well as interference with other substances present in the field. The high sensitivity of the inventive technique in determining the polymer concentration provides better and more accurate forecast for such treatments using simulation models.

The following references are incorporated by reference herein in their entirety.
US2010314114
U.S. Pat. No. 6,454,003, U.S. Pat. No. 6,729,402 and U.S. Pat. No. 6,984,705
U.S. Pat. No. 3,727,688
U.S. Pat. No. 4,068,714
U.S. Pat. No. 3,749,172
U.S. Pat. No. 4,683,949
US2008075667
WO2012021213
WO20100147901

What is claimed is:

1. A composition comprising expandable polymeric particles, said particles having a covalently attached fluorescent tag and having anionic sites and being crosslinked with both labile crosslinkers and stable crosslinkers, said particles combined with a fluid and a cationic crosslinker that is capable of further crosslinking the particle on degradation of the labile crosslinker so as to form a gel.

2. The composition of claim 1, wherein said fluorescent tag is a fluorone, a phenacridine, or a naphthalene based fluorescent dye.

3. The composition of claim 1, wherein said fluorescent tag is a rhodamine, an ethidium bromide or a naphthalene based fluorescent dye.

4. The composition of claim 1, wherein said fluorescent tag is selected from the group consisting of rhodamine 6G, rhodamine B, rhodamine 123, carboxytetramethylrhodamine, tetramethylrhodamine, tetramethylrhodamine isothiocyanate derivative, sulforhodamine B, sulforhodamine 101, Texas Red, rhodamine red, Alexa fluors, DyLight fluors, eosin, auramine O, carboxyfluorescein, fluorescein isothiocyanate, fluorescein amidite, merbromin, erythrosine, Rose Bengal, Oregon Green, Tokyo Green, carboxynaphthofluorescein, ethidium bromide, propidium iodide, ethidium bromide-N,N′-bisacrylamide; 1-anilinonaphthalene-8-sulfonate, dansyl chloride, prodan, N-(N-(acrylamido)ethyl)-4-chloro-1-hydroxy-2-naphthamide, acridine dyes, proflavin, acridine orange, acridine yellow, cyanine, indocarbocyanine, oxacarbocyanine, thiacarbocyanine, and merocyanine, oxazin dyes, Nile Blue, Nile Red, cresyl violet, coumarin derivatives, aminomethylcoumarin acetate, 3-benzoxazol-2-yl-coumarins, 7-aminocoumarin, oxadiazole derivatives, pyridyloxazole, nitrobenzoxadiazole, benzoxadiazole, pyrene derivatives, cascade blue, arylmethine derivatives, auramine, crystal violet, malachite green, tetrapyrrole derivatives, porphin, phtalocyanine, and bilirubin.

5. The composition of claim 1, wherein the anionic site is selected from the group consisting of a carboxylate, a sulfate, a sulfonate, a nitrate, or a phosphate groups.

6. The composition of claim 1, wherein the cationic crosslinker is at least one selected from the group consisting of, Al³⁺, Fe³⁺, Cr³⁺, Ti⁴⁺, Zr⁴⁺, polyethyleneimine (PEI), an alkyl polyamide and an alkene polyamide.

7. The composition of claim 1, wherein the expandable polymeric particles comprise a copolymer of acrylamide and sodium acrylate.

8. The composition of claim 1, wherein the stable crosslinker is methylene bisacrylamide and the labile crosslinker is a diacrylate.

9. The composition of claim 1, wherein the labile crosslinker is a diacrylate.

10. The composition of claim 1, wherein the expandable polymeric particles comprise a copolymer of acrylamide and sodium acrylate, the stable crosslinker comprises methylene bisacrylamide, and the labile crosslinker comprises a polyethylene glycol diacrylate, and the cationic crosslinker is a polyvalent metal cation or a cationic polymer, and the fluorescent tag is a fluorone, phenacridine, or a naphthalene based fluorescent dye.

11. The composition of claim 1, wherein the expandable polymeric particles comprise a copolymer of acrylamide and sodium acrylate, the stable crosslinker comprises methylene bisacrylamide, the labile crosslinker comprises a polyethylene glycol diacrylate, and the cationic crosslinker is at least one selected from the group consisting of a cationic polymer, Al³⁺, Fe³⁺, Cr³⁺, Ti⁴⁺, Sn⁴⁺, Zr⁴⁺ and complexes or nanoparticles containing same, and the fluorescent tag is a fluorone, phenacridine, or a naphthalene based fluorescent dye.

12. The composition of claim 1, wherein the labile crosslinker is an acid labile ketal of the formula: 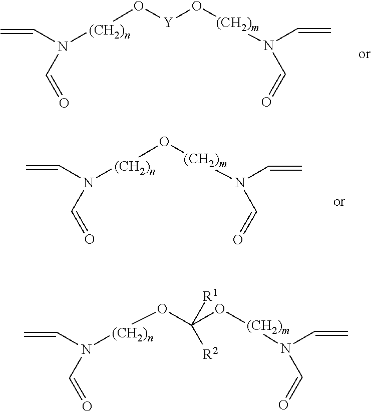
wherein Y is a lower alkyl, where wherein n and m are independently an integer of between 1 and 10, and wherein R¹ and R² are independently a lower alkyl.

13. A composition comprising highly crosslinked expandable hydrophilic polymeric particles having 10-100 ppm of fluorescent tag and 0.5-5 mole % anionic sites and an unexpanded volume average particle size diameter of about 0.1 to about 10 microns and a crosslinking agent content of from about 1,000 to about 200,000 ppm of labile crosslinkers and from 1 to about 300 ppm of stable crosslinkers, combined with a cationic crosslinker and a fluid comprising water.

14. The composition of claim 13, wherein the cationic crosslinker is at least one selected from the group consisting of PEI, or Al³⁺, Fe³⁺, Cr³⁺, Ti⁴⁺, Sn⁴⁺, Zr⁴⁺ and complexes thereof or nanoparticles containing same.

15. The composition of claim 13, wherein the expandable hydrophilic polymeric particles comprise a copolymer of acrylamide and sodium acrylate.

16. The composition of claim 13, wherein the stable crosslinker is methylene bisacrylamide and the labile crosslinker is polyethylene glycol diacrylate.

17. The composition of claim 13, wherein the labile crosslinker is an acid labile ketal, or 2-bis[2,2′-di(N-vinylformamido)ethoxy]propane or 2-(N-vinylformamido)ethyl ether or the labile crosslinker comprises a diacrylate or polyethylene glycol diacrylate, and the expandable hydrophilic polymeric particles comprise polymers of N-vinyl formamide, N-vinylacetamide, N-vinylacetamine, acrylamide, sodium acrylate or mixtures thereof.

18. The composition of claim 13, wherein said fluorescent tag is a fluorone, a phenacridine, or a naphthalene based fluorescent dye.

19. A composition comprising expandable polymeric particles, said particles having a covalently attached fluorescent tag and being crosslinked with both labile crosslinkers and stable crosslinkers, said particles combined with a fluid.

20. The composition of claim 19, wherein said fluorescent tag is a fluorone, a phenacridine, or a naphthalene based fluorescent dye.

21. The composition of claim 19, wherein said fluorescent tag is a rhodamine, an ethidium bromide or a naphthalene based fluorescent dye.

22. The composition of claim 19, wherein said expandable polymeric particles contain at least 0.5 mole percent cationic sites.

23. The composition of claim 19, wherein said expandable polymeric particles contain 0.1-5% hydrophobic monomer.

24. A method of increasing the recovery of hydrocarbon fluids from a subterranean formation comprising injecting into the subterranean formation a composition comprising water, a cationic crosslinker, and a highly crosslinked expandable hydrophilic polymeric particle having fluorescent tags and anionic sites, wherein:
i) said polymeric particle has an unexpanded volume average particle size diameter of 0.05-10 microns and a crosslinker content of about 1,000-200,000 ppm of labile crosslinker and about 0-300 ppm of stable crosslinker,
ii) said polymeric particle has a smaller diameter than the pore throats of the subterranean formation,
iii) said labile crosslinkers break under the conditions of temperature and suitable pH in the subterranean formation to allow the polymeric particle to expand,
iv) said cationic crosslinker then reacts with said expanded polymer to form a gel, and
v) wherein the position and/or amount of fluorescent tag is monitored.

25. The method of claim 24, wherein the cationic crosslinker is a complexed polyvalent cation and is injected into the subterranean formation at the same time as the highly crosslinked expandable polymeric particle.

26. The method of claim 24, wherein the cationic crosslinker is a polyvalent cation and is a injected into the subterranean formation after expansion of the polymeric particle.

27. The method of claim 24, wherein the cationic crosslinker is PEI and is combined with the highly crosslinked expandable hydrophilic polymeric particle prior to injection into the subterranean formation.

28. The method of claim 24, wherein said fluorescent tag is a fluorone, a phenacridine, or a naphthalene based fluorescent dye.

29. A method of increasing the recovery of hydrocarbon fluids from a subterranean formation comprising injecting into the subterranean formation the composition of claim 19, wherein:
i) said polymeric particle has an unexpanded volume average particle size diameter of 0.05-10 microns and a crosslinker content of about 1,000-200,000 ppm of labile crosslinker and about 0-300 ppm of stable crosslinker,
ii) said polymeric particle has a smaller diameter than the pore throats of the subterranean formation,
iii) said labile crosslinkers break under the conditions of temperature and suitable pH in the subterranean formation to allow the polymeric particle to expand, and
iv) wherein the position and/or amount of fluorescent tag is monitored.
